(19) United States
(12) Patent Application Publication
(10) Pub. No.: US 2009/0303128 A1
(43) Pub. Date: Dec. 10, 2009

(54) Optically Reconfigurable Multi-Element Device

(76) Inventors: Jean-Luc Robert, Betton (FR); Philippe Minard, Saint Medard Sur Ille (FR); Nicolas Boisbouvier, Evian Les Bains (FR); Christophe Prat, Coueron (FR)

Correspondence Address: Thomson Licensing LLC, P.O. Box 5312, Two Independence Way, PRINCETON, NJ, 08543-5312, US

(21) Appl. No.: 11/922,367

(22) PCT Filed: Jun. 14, 2006
(86) PCT No.: PCT/EP2006/063204

§ 371 Date: Jul. 21, 2009

(30) Foreign Application Priority Data
Jun. 20, 2005 (JP) 05551672

(51) Int. Cl. H01Q 3/26

(52) U.S. Cl. 342/373

(57) ABSTRACT

The invention relates to an optically reconfigurable multi-element device. An optical matrix formed by a set of optical elements, such as elements of OLED type, makes it possible to actuate a matrix of photoconductive elements, which will allow connection to be made between the various elements of the device to be reconfigured.

The present invention relates to a radiofrequency or microwave device comprising several optically reconfigurable elements. This type of device is needed in latest wireless communication media located mainly within frequency bands lying between the UHF frequency band (470-860 MHz) up to a few GHz for digital television and frequencies currently allocated for access to broadband high data rate services spread over a few GHz for applications of the WLAN (Wireless Local Area Network) type (2.4 GHz—IEEE 802.11b, 5.8 GHz—IEEE 802.11a, 3.5 GHz, WiMAX) up to a few tens of GHz for links of the LMDS (Local Multipoint Distribution System) type (28 GHz) or satellite links for microwave devices.

For a number of years, communication systems allowing subscribers access to broadband service or BWA (Broadband Wireless Access) are requiring ever stricter performance, for example in terms of bandwidth, frequency diversity, size reduction, coverage area and immunity from interference or electromagnetic disturbance.

These considerations have led industrial designers of transmission equipment to produce innovative devices that are reconfigurable in terms of certain RF (radiofrequency) functions or certain microwave functions, such as phase-shifting or filtering functions, or other functions for matching systems or, more particularly, for antennas. The smart antenna technology thus has the potential of greatly improving system performance in terms of coverage, transmission capability, link quality or the possibility of locating the direction of possible jammers. This concept is possible, using a control signal, to combine multiple antenna elements in order to optimize the radiation pattern with respect to the environment. This technology is particularly used for switched-beam array antennas or adaptive arrays.

Unlike fixed antennas, which can only radiate in a single pattern, reconfigurable antennas have the possibility of radiating in several patterns as a result of modifying their physical configuration.

Considerable research is currently being carried out in the field of reconfigurable concepts of planar structure.

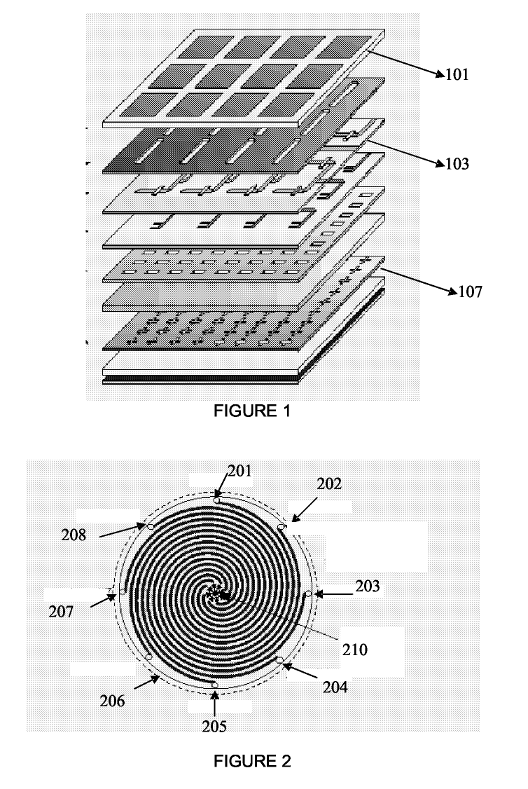

FIG. 1 shows a reconfigurable antenna concept based on MEMS (microelectromechanical system) or PBG (photonic bandgap) technology.

This major technology, which is based on the switching of antenna elements 101 jointly with configuration of the multilayer substrate 101 . . . 10N type, one of the layers 103 being formed from MEMS arrays and another 107 having a PBG structure, relies on various electromagnetic structures.

Recent technological progress in the MEMS field thus allows the physical connection or disconnection of sections of the various conducting regions constituting the antenna, but at the present time it requires very substantial control elements for connecting the various sections constituting the antenna.

Japanese document JP2000022428 describes a multi-element antenna of the phased-array type, intended for portable terminals incorporating antenna elements and phase-shifting elements. The switching of the various phase-shifting elements is provided by amorphous silicon TFT transistors. The main problem lies in the high resistivity of these transistors, which are not very effective at RF frequencies. To alleviate this drawback, the parallel integration of 100 TFT transistors is proposed.

Other concepts, such as that shown in FIG. 2, use a switching technique based on PIN diodes 210 and optoelectronically controlled RF switches 201, 202, . . . , 208.

However, these systems based on active RF switches or PIN diodes or TFT transistors require polarization that makes the connection of the radiating conducting sections, for example of the pixellated type, relatively complex.

In addition, by using arrays of active RF switches it is not possible to achieve great control flexibility when reconfiguring the active elements, nor is sufficient isolation provided between the control circuits and the RF or microwave electronics.

To remedy these drawbacks, the invention proposes an optically reconfigurable multi-element device. The control structure for connecting the elements of the device is an optical structure.

The invention consists of a reconfigurable device comprising N RF or microwave circuit elements and having connection means capable of connecting the elements to one another. It is characterized in that said connection means can be actuated optically.

One of the advantages of this optical solution is the perfect electromagnetic isolation between the control circuits and the RF/microwave electronics of the equipment.

Another advantage is the absence for active switching components requiring to be biased.

Other recognized advantages are a very low insertion loss of the device providing the switching operation and a response time substantially shorter than that obtained with a device such as a MEMS device.

The subject of the invention is also a reconfigurable device in which, when the elements are organized in the form of a matrix, said connection means are organized in the form of a connection matrix that can be actuated optically.

According to an alternative embodiment of the invention, an OLED-type (optical light-emitting diode) multilayer optical element is associated with each connection element, the optical element allowing the connection to be actuated.

These OLED-type optical elements may be organized in the form of an active matrix associated with the matrix of connection means.

Preferably, the connection elements of the reconfigurable device are formed by a layer of a photoresistive material of low resistivity interposed between the OLED element and the conducting zones of the multi-element device or are formed by non-biased photonic active elements.

The advantage of this solution lies mainly on an OLED technology that is presently well understood and of low cost, because its main application is in flat screens, and on possible applications within a wide frequency range given the current sizes (ranging from a few inches to 40 inches) of manufacturable OLED-based screens.

In an alternative embodiment, the matrix of optical elements is associated with a dynamic control device, called a driver, various optical elements forming the connection points. Optionally, it includes a memory region containing a program for the various envisaged configurations. It is also envisaged for the matrix of connections to be produced in the form of a mask associated with the matrix of optical elements in correspondence with the desired connection points.

The advantage of this solution lies mainly in the flexibility in reconfiguring the elements, which may from now on be completely dynamic or preprogrammed.

There are many applications of the invention. The invention applies more particularly to an antenna formed by optically reconfigurable elements, in a given configuration, of a device.

The advantage of this solution lies in the fact of being able to envisage novel reconfigurable and conformable antenna concepts, the OLEDs being fabricated on flexible substrates (plastic or metal films).

The invention also applies to a phased-array circuit formed by optically reconfigured elements, in a given configuration, of the reconfigurable device.

Likewise, it applies to an RF or microwave array circuit formed by elements optically reconfigurable in a given configuration.

Another application of the invention also relates to phase shifters of PBG (photonic band gap) structure that are formed by reconfigured elements of an optically reconfigurable device in a given configuration.

The invention will be better understood and other features and advantages will become apparent on reading the following description, given with reference to the appended drawings in which:

FIG. 1 shows a reconfigurable antenna concept according to the prior art;

FIG. 2 shows a switching technique according to the prior art;

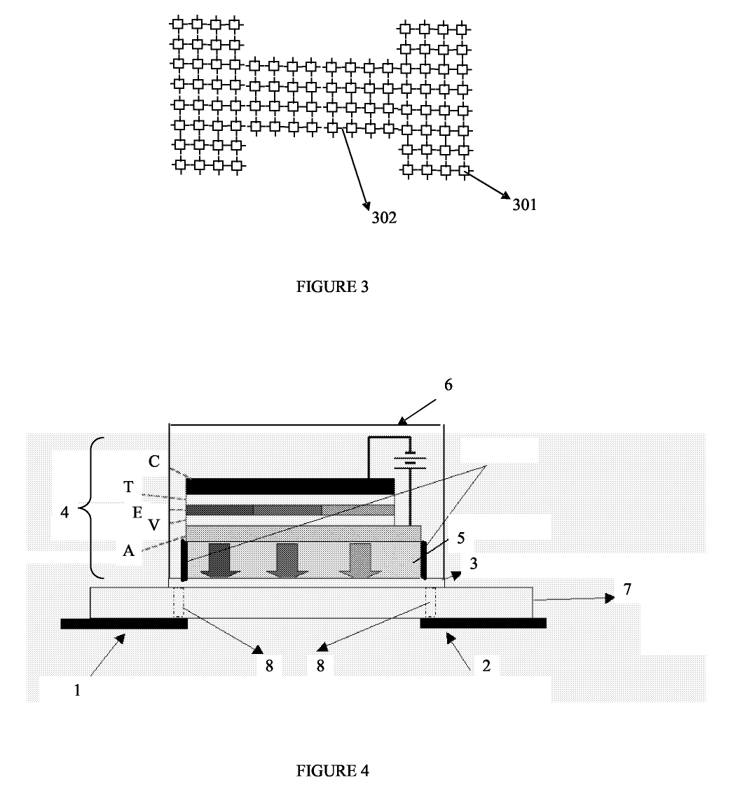

FIG. 3 corresponds to an example of the topology of a matrix in the form of pixels for producing an RF/microwave circuit according to the invention;

FIG. 4 shows the details of the connection element located between the pads 1 and 2;

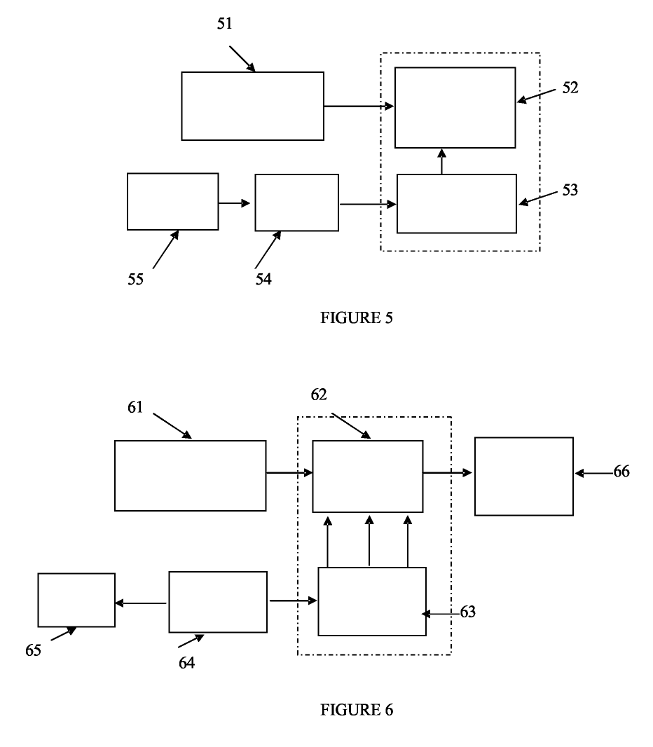

FIG. 5 shows a first embodiment of the proposed concept;

FIG. 6 shows a second embodiment of the proposed concept;

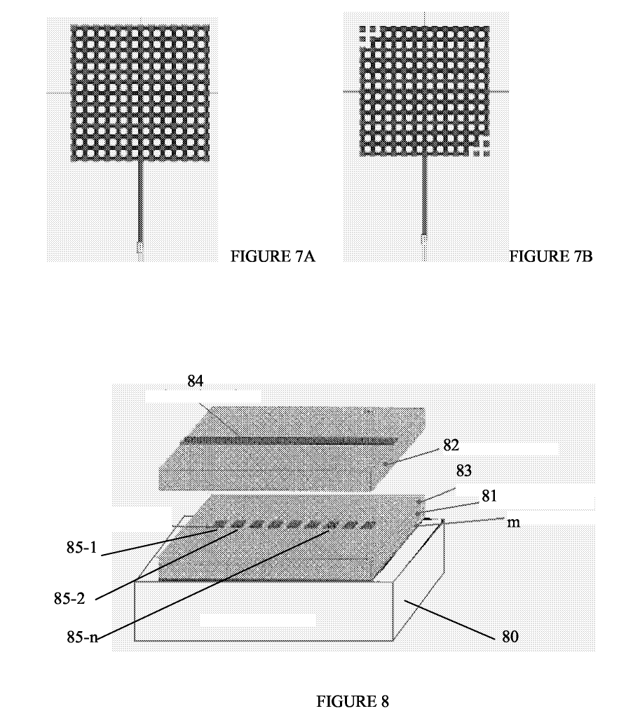

FIG. 7 illustrates an example of one possible function with this type of optical connection; and

FIG. 8 shows a third possible application of this optical switch.

FIGS. 1 and 2, showing circuits of the prior art and having been briefly described above, will not be explained in further detail below.

FIG. 3 corresponds to an example of the topology of a matrix in the form of pixels for producing an RF/microwave circuit according to the invention. Each RF or microwave circuit element is represented in FIG. 3 by a square 301. The elements may have an antenna function, a phase-shifter function or an array function within the range of RF or microwave frequencies. Each element 301, also called a pad, can be connected to the other elements that surround it. This connectability is represented in FIG. 3 by the dashes 302 attached to the squares 301 representing the various elements. By connecting various elements together in a certain configuration, the desired device with a chosen function is obtained.

The invention consists in optically connecting these various elements by photoconductive elements (not visible in the matrix of elements shown in FIG. 3).

Light emission on one of these photoconductive elements makes this photoconductive element conductive and therefore provides the connection between the corresponding elements. The cell for bringing two consecutive elements into contact with each other is based on the principle of a semiconductor photoconductive cell. Under light illumination, photocarriers are created in the active element of the device, causing an increase in conductivity of the material and therefore causing the cell to conduct.

The connection elements may also be photonic devices. Some of these photonic devices behave like the photoconductive elements described above, light emission rendering them conductive.

Other photonic devices show an opposite behaviour: they are conductive without light emission, while light emission interrupts their conduction.

The connection elements are assembled into a matrix of connections associated with the matrix of circuit elements described in FIG. 3.

According to the invention, the connection element, also called the active element, may be obtained by simply depositing a layer of semiconductor material, whether doped or not, with a junction or not, and possibly also including devices of the transistor or diode type. The material may be an amorphous silicon (a-Si), or any other semiconductor alloy whose photoconductive properties are well known and used for the production of photovoltaic cells (for example GaAs). This layer deposited on a substrate is etched so as to conform to the matrix of connection points to be produced.

The connection element may also be a photonic device.

In the field of electroluminescent devices, OLEDs have a better rendition than other solutions, such as for example LCDs (liquid-crystal devices). However, this technology, and other optical technologies, may of course be envisaged for generating the desired light emission for the photonic or photoconductive elements, while still following the teaching of the invention.

The novel and innovative solution proposed within the reconfigurability context according to the invention is based on a particular exploitation of the OLED technology. The matrix used to connect the various elements shown in FIG. 3 is therefore, in the example described, associated with an active matrix formed from OLEDs, each connection point being superposed with an OLED pixel. When the OLED is actuated, driven by a conventional driver, the photoconductive element becomes conducting.

FIG. 4 shows the details of the means of connection 3 between the elements 1 and 2, which is formed using a photoresistive element associated with an OLED-type electroluminescent element 4.

An emissive OLED structure consists of a stack of organic layers deposited between two (metal or oxide) electrodes, the charges needed to create excitons, and consequently to generate light, being injected there into.

Between the organic layers of the 2 electrodes, that is to say the cathode C and the anode A, is an emitting layer E separated from the cathode by an electron transport layer T and from the anode by a hole transport layer V. A certain potential between the cathode and the anode therefore generates light. The anode is transparent and may have a thickness for example of 100 nm. The reflective cathode has a thickness for example of 100 to 200 nm, the various intermediate layers each have a thickness for example ranging from 20 to 100 nm.

This OLED light-emitting element rests on a glass substrate 5. The substrates allowing the propagation of light rays may be used.

This stack must be protected from oxygen and moisture of the ambient atmosphere by a glass or metal cover 6.

The microwave substrate 7 providing the pixellated reconfigurable function is the last element of this multilayer structure. The contacts between the layers are provided by vias 8.

In the example shown in FIG. 4, the connection element 3 is formed by a photoresistive layer deposited on a glass substrate resting on the pads 1, 2 to be connected or on the glass substrate 5 supporting the OLED element 4. The vias 8 provide the connections between this photoresistive layer 3 and the respective pads 1 and 2.

The photoresistive layer 3 may be deposited directly on the pads 1 and 2 without the intermediary of a substrate made of glass or equivalent material.

In the example shown in FIG. 4, light emission by an OLED element 4 therefore makes the photoconductive element conducting and thus creates an electrical link between the two pads shown.

We described a connection element 3 associated with an OLED element 4. The matrix of such connection elements associated with an OLED matrix will provide the optical connections between the various RF or microwave circuit elements organized in the form of a matrix of the multi-element device. This matrix may be formatted in the desired configuration, as we will see in the exemplary embodiments according to the invention and shown by FIGS. 5, 6 and 8. It is defined by a metal impression constituting a pixellated-type matrix of pads connected to connection means. It is also possible to produce a mask of this layer in accordance with the desired switching points.

The pixellated conducting section has by definition a high-impedance surface. One advantage of the invention is to use the properties of the high-impedance surface to form one or more devices comprising RF or microwave circuit elements. Assuming that an OLED matrix is used and that the footprint for the desired RF or antenna function represents only a portion of this OLED matrix, the function thus produced will be the presence of pixels that are partially or completely connected together, or not. The influence of these pixels placed around or near the function is well known to those skilled in the art, and is combined with a high-impedance surface. These high-impedance surfaces are often used among other things to remove the surface waves or to increase the isolation between two devices. It is possible to use these high-impedance surfaces so as to benefit from this type of structure or in such a way that these surfaces do not disturb the RF or antenna function.

The device is formed by the superposition of the microwave substrate, constituting the elements of the RF or microwave function, and of the multilayer structure formed by the OLED and the photoconductive elements.

A device for dynamically controlling the state of the connection elements is formed by a driver, which drives the OLED matrix. This driver may also contain memory elements in which various RF or microwave circuit reconfiguration scenarios are stored.

Many applications of this concept may be envisaged in the field of reconfigurable antennas, but also in the field of multiple tuneable RF or microwave circuits, such as filtration circuits, matching systems, phase shifters. Thus, these antennas offer the flexibility of matching the operating parameters, for example the frequency, the RF level or the impedance. These matching properties are highly desirable in the field of wireless communications.

FIGS. 5 and 6 show first and second embodiments of the proposed concept, which therefore consists in producing a device by the connection of N elements thus producing a given RF or microwave function. In the case of this first application, shown in FIG. 5, the desired function is a reconfigurable antenna function. FIG. 5 shows transmit/receive elements 51 associated with a planar antenna 52 reconfigured using the OLED connection matrix 53, defined as the combination of the two associated matrices, namely the connection matrix and the OLED matrix. It may also be defined by a metal impression consisting of a pixellated-type matrix of elementary pads. The reconfiguration of the desired antenna function may be stored in a memory element 55 connected to an element 54 for driving the OLED pixels.

Each of the pads is therefore electrically connected to the selected neighbouring elements via an optical switch for configuring the desired antenna function.

The concept shown in FIG. 6 therefore consists of a device for carrying out a new microwave function reconfigurable by acting on its physical parameters, the desired function in the case of this second application being a phase-shifting function.

It relates to the phased arrays of a multibeam antenna 66. The phased arrays may be controlled in particular using a reconfigurable RF phase shifter 62 in which two phase-shift states are obtained by modifying the states of the optical switches of the OLED matrix 63. A transmit/receive element 61 transmits/receives a signal to/from the phase shifter 62, which will transmit it to or will have received it from the multibeam antenna 66. As in FIG. 5, a drive element 64 associated with a memory 65 controls the OLED connection matrix 63.

The FIG. 7 illustrate two matrixes of pixels which are example of a function possible with this type of optical connection based on a pixellated matrix.

The OLED matrix used here makes it possible to switch two working frequencies f1 and f2 (FIG. 7a) onto another working frequency f3 (FIG. 7b) in disconnecting three pads situated in two corners.

A third possible application of this optical switch is shown by FIG. 8, which allows a PBG structure to be actively reconfigured. By varying the number of periodic features constituting the PBG structure, we propose changing the properties of this PBG structure.

This is a PBG structure consisting of metal features periodically repeated beneath a microstrip-type transmission line 84. The ground plane m of the microstrip line is then that of the anode of the OLED 80 (upper surface). The substrate 81 is a glass substrate on which the photoresistive layer 83 is deposited. The substrate 82 is a conventional dielectric substrate.

It is known that, by modifying the number of repeated features 85-1, 85-2, . . . 85-n beneath the microstrip line 84, the phase of the transmission coefficient is varied. The larger the number of features, the greater the phase shift of the transmission coefficient. The optical switch, proposed in this invention, therefore makes it possible for “actively” switching from one PBG configuration to another. Depending on the way in which the OLED is driven, the latter will “illuminate”, and therefore make photoconducting, a number n or n′ of periodically spaced features 85 on the photoresistive layer 83.

For example, a phase shift achievable in three PBG configurations is compared. These consist respectively of 3, 5 and 7 square features with sides a=2.3 mm, periodically spaced apart by 18.4 mm. The dielectric substrate denoted 82 has a dielectric permittivity of 83.38 and a thickness of 0.81 mm. A phase change of −17°, −23° and −36°, respectively, is then for example achievable at 3.5 GHz with a PBG structure consisting of 3, 5 and 7 metallized features respectively.

This invention is not limited to the applications described above but allows many applications in the reconfigurable antenna field and also allows multiple tuneable RF or microwave circuits to be envisaged (filtration, matching systems, phase shifters), thus offering the possibility of matching the operating parameters, such as the frequency, the RF level, the impedance or other parameters, which properties are highly desirable in the field of wireless communications.

1. Reconfigurable device comprising N RF or microwave circuit elements organized in the form of a matrix and having electrically connection means capable of connecting the elements to one another, wherein said connection means are organized in the form of a matrix of connections that can be switched optically.

2. Reconfigurable device according to claim 1, wherein each connection means is associated with a multilayer optical element for actuating the connection.

3. Reconfigurable device according to claim 2, wherein the multilayer optical element is of OLED type.

4. Reconfigurable device according to claim 3, wherein the optical elements of OLED type are organized in the form of an active matrix associated with the matrix of connection means.

5. Reconfigurable device according to claim 4 wherein the connection means are formed by a layer of photoconductive material of low density interposed between the optical element and said N elements.

6. Reconfigurable device according to claim 5, wherein the connection means are formed by non-biased photonic active elements.

7. Reconfigurable device according to claim 3, wherein the matrix of optical elements is associated with a device for dynamically driving the various elements forming the connection points.

8. Reconfigurable device according to claim 7, wherein the drive device includes a memory region containing a program for the various envisaged configurations.

9. Reconfigurable device according to claim 8, wherein the matrix of connections is produced in the form of a mask associated with a matrix of optical elements in accordance with the desired connection points.

10. Antenna formed by elements of a reconfigurable optical device in a given configuration, as claimed in claim 1.

11. Phased-array circuit formed by elements of an optically reconfigurable device in a given configuration as claimed in claim 1.

12. Reconfigurable array circuit formed by elements of an optically reconfigurable device in a given configuration as claimed in claim 1.

13. Phase shifter of PBG structure formed by elements of an optically reconfigurable device in a given configuration as claimed in claim 1.
